(19) United States
(12) Patent Application Publication
(10) Pub. No.: US 2023/0377778 A1
(43) Pub. Date: Nov. 23, 2023

(54) COATED CONDUCTOR IN A HIGH-VOLTAGE DEVICE AND METHOD FOR INCREASING THE DIELECTRIC STRENGTH

(71) Applicant: Siemens Energy Global GmbH & Co. KG, München (DE)

(72) Inventors: Thomas Heinz, Berlin (DE); Armin Grund, Berlin (DE); Volker Lehmann, Treuenbrietzen (DE)

(21) Appl. No.: 18/029,446

(22) PCT Filed: Sep. 13, 2021
(86) PCT No.: PCT/EP2021/075060

§ 371 Date: Mar. 30, 2023

(30) Foreign Application Priority Data
Sep. 30, 2020 (DE) 10 2020 212 384.5

(51) Int. Cl. H01B 17/42; H01B 7/02; H02B 13/035

(52) U.S. Cl. CPC H01B 17/42; H01B 7/0291; H02B 13/0358

(57) ABSTRACT

A high-voltage device has an encapsulation housing and at least one bushing for at least one electrical conductor leading into the encapsulation housing and/or leading out of the encapsulation housing. The at least one electrical conductor is coated with an insulation layer. The insulation layer increases the dielectric strength in the high-voltage device, in particular in the region of the bushing.

The invention relates to a high-voltage device and a method for increasing the dielectric strength in a high-voltage device, wherein the high-voltage device includes an encapsulation housing and at least one bushing, for at least one electrical conductor into the encapsulation housing and/or out of the encapsulation housing.

High-voltage devices are designed for voltages in a two-figure kilovolt range up to a voltage range of several hundred kilovolts, in particular 1200 kV, and for currents in the range of up to several hundred kiloamps. High-voltage devices comprise, for example, high-voltage circuit breakers, isolators, transformers, arrestors, measurement transducers, and/or bushings. High-voltage devices, in particular circuit breakers, are designed, for example, as open air and/or as gas-insulated circuit breakers, i.e., gas-insulated switch gears, which are designed as live tank, i.e., at a high voltage potential, having a switching unit arranged in an insulator, or as dead tank, i.e., having a switching unit arranged in a grounded housing.

Dead tank gas-insulated circuit breakers include an encapsulation housing, for example made of aluminum, which is designed in particular in the form of a cylindrical vessel, and bushings for electrical conductors, in order to connect switching units which are arranged in the interior of the encapsulation housing to power consumers, power generators, and/or power lines of a power grid. The electrical conductors are live conductors in operation, depending on the operating state, for example in the case of a closed circuit breaker and applied high voltage. The encapsulation housing, in particular in vessel form, is designed to be gas-tight, having two openings, for example, which are circular in particular, and which are designed in the form of flanges, to which in particular hollow-cylindrical insulator housings are fastened in a gas-tight manner. The electrical conductors extend in the insulator housings or insulators, starting from outer terminal lugs at an end of the insulators closed gas-tight, to the openings in the encapsulation housing and through to, for example, the switching unit, to electrically connect the switching unit to power consumers, power generators, and/or power lines of the power grid.

The encapsulation housing of the high-voltage device, in particular the circuit breaker, is arranged on a carrier, for example on steel struts, which are anchored in a mechanically stable manner in particular in a concrete foundation. The encapsulation housing is electrically grounded in order to minimize hazards for maintenance personnel and/or persons in the surroundings. Insulators, in particular in oblong hollow cylinder form, are arranged or fastened on one side of the encapsulation housing, which is opposite to the side of the carrier, and point, for example, perpendicularly or at an angle away from the encapsulation housing, in particular upward away from the encapsulation housing. A sufficient electrically insulating distance of the terminal lugs from the ground potential and/or foundation is thus provided to prevent electrical flashovers. In the interior, the encapsulation housing and the insulators are filled with an insulating and/or switching gas, in particular SF₆.

The insulating gas insulates, for example, the switching unit and the electrical or live conductors in the interior of the high-voltage device in relation to the grounded encapsulation housing. In the area of the bushings, in particular the transitions from the circular openings in the encapsulation housing, which are designed in the form of flanges, to the fastened, in particular hollow-cylindrical insulators, a sufficient dielectric strength is to be ensured between the grounded encapsulation housing and the electrical conductors, in particular at high voltage potential. In the case of circular openings in the encapsulation housing, the electrical conductors are arranged equidistantly to the encapsulation housing, in particular perpendicularly penetrating the circle plane of the openings in the circle center point. The openings have a size or a circumference which, depending on the maximum voltage of the high-voltage device and the insulating gas used and its pressure, ensures sufficient dielectric strength to reliably prevent electrical flashovers between the conductor and the encapsulation housing.

Electrical fields or field spikes in the area of the openings are changed or reduced, i.e., shielded, by grounded electrodes, in particular circular, hollow-cylindrical metal electrodes arranged in the interior of the insulator and mechanically fastened on the flange of the encapsulation housing, originating from the live conductor. High voltages of the high-voltage device are thus possible, in particular in the range of several hundred kilovolts, without electrical flashovers and/or short-circuits between electrical conductors at high voltage potential in the high-voltage device, in particular in the area of the bushings, and the grounded encapsulation housing. High voltage levels of the high-voltage device require, for continuous, safe operation, large diameters of the openings in the encapsulation housing, which is linked to high costs for insulators having large circumference, require switching gases having high dielectric strength, in particular SF₆, and/or high pressures of the switching gases, which is linked to high costs for large wall thicknesses of the insulators and encapsulation housing, in order to permanently ensure sufficient mechanical stability.

Switching gases such as SF₆ are harmful to the climate. Alternative switching gases, such as clean air, i.e., purified air, have a lower dielectric strength. The use of climate-friendly switching gases, such as clean air, thus requires larger opening diameters of the openings in the encapsulation housing and/or higher pressures of the switching gas, with the above-described disadvantages. Measures, such as the use of grounded control electrodes, increase the dielectric strength only to an extent that is inadequate for certain voltage levels. The use of the high-voltage circuit breakers is thus restricted.

The object of the present invention is to specify a high-voltage device and a method for increasing the dielectric strength in a high-voltage device which solve the above-described problems. In particular, it is an object to specify a high-voltage device which enables high voltage levels in a cost-effective and material-saving manner, in particular upon use of alternative switching gases such as clean air, with high dielectric strength in the area of bushings of the high-voltage device, in particular upon use of switching gases having low gas pressures, for example in the range of the ambient air, and/or with diameters of the bushings in the order of magnitude of bushings in high-voltage devices filled with SF₆ or smaller.

The specified object is achieved according to the invention by a high-voltage device having the features as claimed in claim 1 and/or by a method for increasing the dielectric strength in a high-voltage device, in particular an above-described high-voltage device, as claimed in claim 14. Advantageous embodiments of the high-voltage device according to the invention and/or the method according to the invention for increasing the dielectric strength in a high-voltage device, in particular an above-described high-voltage device, are specified in the dependent claims. Subjects of the main claims can be combined with one another and with features of dependent claims, and features of the dependent claims can be combined with one another.

A high-voltage device according to the invention comprises an encapsulation housing and at least one bushing for at least one electrical conductor. The at least one electrical conductor leads into the encapsulation housing and/or out of the encapsulation housing. The at least one electrical conductor is coated using an insulating layer.

The insulating layer enables the use of bushings having small diameter, in particular upon the use of climate-friendly switching gases, such as clean air, as an alternative to climate-damaging switching gases, such as SF₆. The high-voltage device having at least one electrical conductor, which is coated using an insulating layer, is thus designed in a cost-effective and material-saving manner, in particular due to the possibility of using bushings having small diameter, in particular upon the use of climate-friendly switching gases such as clean air, and enables the use of switching gases at low gas pressures, for example in the range of the ambient air, which permits encapsulation housings and insulators having low wall thicknesses, at high voltage levels, with high dielectric strength in the area of the bushings of the high-voltage device.

In a gas-insulated circuit breaker, for example, having an electrical conductor in a bushing into or out of the encapsulation housing, the highest field strength occurs at the surface of the electrical conductor. A coated dielectric material results due to the insulating layer applied to the electrical conductor, by which the point of the otherwise highest field strength on the surface of the electrical conductor is reduced and, with an optimally selected insulating layer thickness, the electrical field strength in the critical area is made approximately uniform. In addition, the probability of free strong electrons for initiating an electrical flashover is inhibited by the insulating layer. Local field elevations due to surface roughness are reduced or prevented. The reliability and service life of the high-voltage device are thus increased, and maintenance intervals can be reduced, by which personnel and cost expenditure are reduced.

The at least one electrical conductor can be completely coated using an insulating layer along its length. An insulation completely along the length of the electrical conductor has the above-described advantages, not only in the area of the bushing, but along the entire conductor.

The at least one electrical conductor can alternatively be coated with an insulating layer exclusively in the area of the bushing, in particular in the area of an opening in the encapsulation housing. Material and costs are thus saved in comparison to a complete coating, and a deliberate advantageous influencing of the electrical field in the area of the bushing is possible. By displacing field components away from the bushing, flashovers can be reduced or prevented in the area of the bushing, and the dielectric strength can be increased in particular in the area of the bushing or an opening in the encapsulation housing, wherein the area represents a particularly critical area with respect to the field strength and probability of flashover or short-circuit.

The insulating layer can have a relative permittivity in the range of 1, in particular greater than 1. Due to the insulating layer applied to the electrical conductor, the relative permittivity of which is somewhat greater than that of gas, thus is greater than 1, a coated dielectric material results, due to which the point of the otherwise highest field strength at the surface of the in particular metallic inner conductor is reduced and, with an optimally selected insulating layer thickness, the electrical field strength in the critical area is made approximately uniform. Due to the optimization of the dielectric permittivity of the insulating layer material and the thickness of the layer, the field strength can be set so that the electrical field strength at the metallic inner conductor, i.e., at the electrical conductor, and at the surface of the applied insulating layer are identical.

The insulating layer can consist of more than one layer, in particular having decreasing permittivity from layer to layer, in particular having the highest permittivity of the layer directly in connection with the at least one electrical conductor. Due to the application of further insulating layers having different relative permittivity, wherein, for example, the permittivity of the inner layer is highest, and each further layer is formed having a lower or having decreasing permittivity, but always having a permittivity greater than the permittivity of gas, more pronounced equalization of the electrical field can be achieved in comparison to only one layer, in order to thus give further relief to the critical areas dielectrically.

The insulating layer can be made of silicone, Teflon, PTFE, and/or PCTFE, and/or can comprise silicone, Teflon, PTFE, and/or PCTFE. These materials are cost-effective, easy to process, in particular easily applicable as a layer, having a permittivity greater than 1, electrically insulating, and thus well suitable as an insulating layer.

The insulating layer can be formed having a layer thickness in the range of millimeters and/or in the range of centimeters. In the case of multiple layers, in particular a layer thickness in the range of millimeters provides good electrical insulation, wherein a total layer thickness can be in the range of centimeters. Depending on the material, layer thicknesses in the range of millimeters or centimeters are sufficient to achieve the desired effect, having the above-described advantages.

The thickness and the dielectric permittivity of the insulating layer can be selected in such a way that the field strength at the surface of the electrical conductor, in particular in uncoated areas, and at the outer surface of the insulating layer are equal. Flashovers through the insulating layer and between conductor and insulating layer are thus minimized or precluded.

The encapsulation housing can include a flange and an insulator, in particular a hollow-tubular and/or circular-cylindrical insulator, in particular made of silicone, ceramic, and/or composite materials in particular having ribs on the outer circumference, can be fastened in a mechanically stable manner on the flange, in particular with a center axis of the insulator congruent to a longitudinal axis of the at least one electrical conductor. A flange enables a mechanically stable, permanently strong, and in particular gas-tight fastening of an insulator on the encapsulation housing. A gas-tight housing of the high-voltage device having encapsulation housing and insulators is thus possible, which at least partially has electrically shielded conductors in the housing. The conductors, electrodes, and/or units, such as switching units, in particular arranged in the insulator and/or encapsulation housing, are thus protected, for example, from weather influences.

At least one electrode at ground potential can be enclosed by the bushing, in particular spatially enclosed. A further shielding of electrical fields in the area of the openings in the encapsulation housing is thus provided, in particular a good shielding of the openings in relation to the electrical or live conductor. The combination of an electrode at ground potential with an insulating layer on the electrical conductor results in a high dielectric strength in the area of the bushings and/or in the area of the openings in the encapsulation housing, with the above-described advantages. The combination increases the dielectric strength in particular in the area of the bushing in addition to a use of only one or multiple insulating layers. The arrangement of the at least one electrode at ground potential around the electrical conductor, spaced apart from the electrical conductor, which is provided with at least one insulating layer, enables a grounded arrangement or fastening of the electrode at ground potential on the encapsulation housing or on the flange of the encapsulation housing around the openings, with a high shielding effect. The at least one electrode at ground potential can be constructed from or consist of a metal, in particular copper, aluminum, and/or steel, and/or a metallic alloy. Metals result in good electrical shielding effects, are cost-effective, and are easily producible in any shape or easily processable.

The insulator can be arranged congruently with a center axis or identically to a center axis of at least one electrode at ground potential and/or the longitudinal axis of the at least one live or electrical conductor. This results in a space-saving, cost-effective arrangement, having good shielding effect of the electrode.

At least one switching unit of a high-voltage circuit breaker can be comprised, in particular arranged in the encapsulation housing and/or connected via the at least one electrical conductor to power consumers, power generators, and/or lines of a power grid. Switching units of high-voltage circuit breakers are installed in encapsulation housings of the above-described type, having at least one bushing for at least one live or electrical conductor, to which the above-described advantages are linked in particular for the high-voltage circuit breakers as high-voltage devices.

The at least one electrical conductor can consist of a metal, in particular copper, aluminum, and/or steel, and/or of a metallic alloy. The at least one electrical conductor can have the shape of an in particular circular-cylindrical bar and/or a rod. Metals, such as copper, aluminum, and/or steel, are good electrical conductors and have low electrical losses even at high amperages, in particular in the range of up to several hundred amps, in a high-voltage device. A good electrical connection of electrical units of the high-voltage device, for example of switching units, to external power consumers, power generators, and/or power lines in the power grid is thus possible with low electrical losses in operation of the high-voltage device. The rounded shape of electrical conductors, in particular formed as circular-cylindrical bars and/or as rods, in particular having a diameter in the range of centimeters, prevents voltage elevations at edges and results in electrical field distributions around the electrical conductor in the live state, which minimize or prevent electrical flashovers in the area of the bushings.

The high-voltage device, in particular the encapsulation housing and/or the bushing, can be filled using clean air. Clean air is cost-effective and environmentally friendly, in particular climate neutral. A lower dielectric strength of clean air in relation to conventional insulating gases, such as SF₆, can be compensated for by the use of an insulating layer on the electrical conductor in particular in the area of openings in the encapsulation housing with live or electrical conductors led through. A use of identical encapsulation housings for different insulating gases is thus possible, which enables a simple exchange in existing high-voltage devices, upon use of insulating layers on the electrical conductors in particular in the area of the bushings, with climate-friendly effects, and cost-effectively enables high piece counts in new facilities, in particular upon the use of climate-friendly insulating gases. Encapsulation housings and insulators having small dimensions can be used, which saves material and costs, with the above-described advantages.

A method according to the invention for increasing the dielectric strength in a high-voltage device, in particular in an above-described high-voltage device, comprises that at least one electrical conductor is coated using an insulating layer, in particular in an area of a bushing for the at least one electrical conductor leading into an encapsulation housing of the high-voltage device and/or leading out of the encapsulation housing.

The advantages of the method according to the invention for increasing the dielectric strength in a high-voltage device, in particular in an above-described high-voltage device, as claimed in claim 14 are analogous to the above-described advantages of the high-voltage device according to the invention as claimed in claim 1 and vice versa.

An exemplary embodiment of the invention is schematically shown in the figures below and described in more detail hereinafter.

In the FIGS.

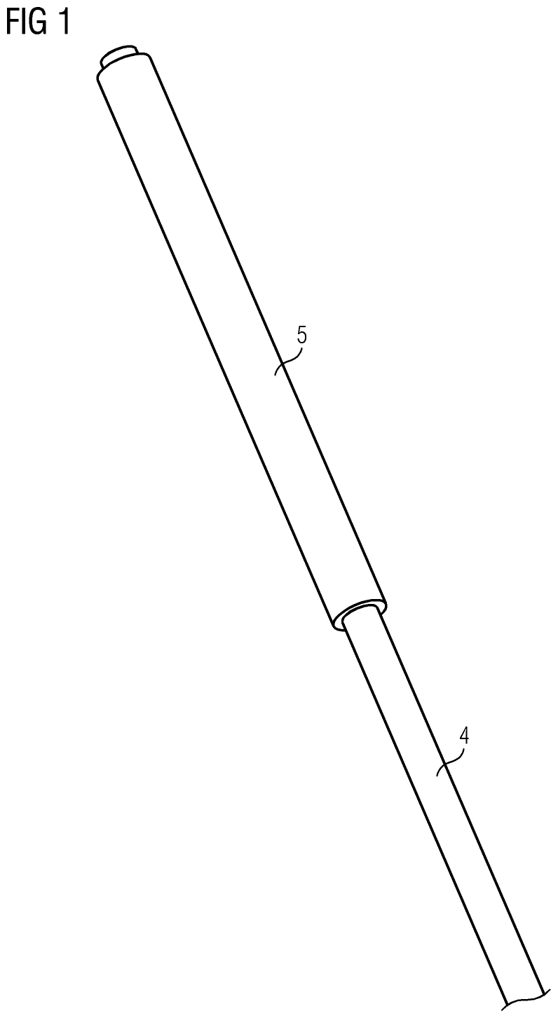

FIG. 1 schematically shows an electrical conductor 4 coated using an insulating layer 5, and

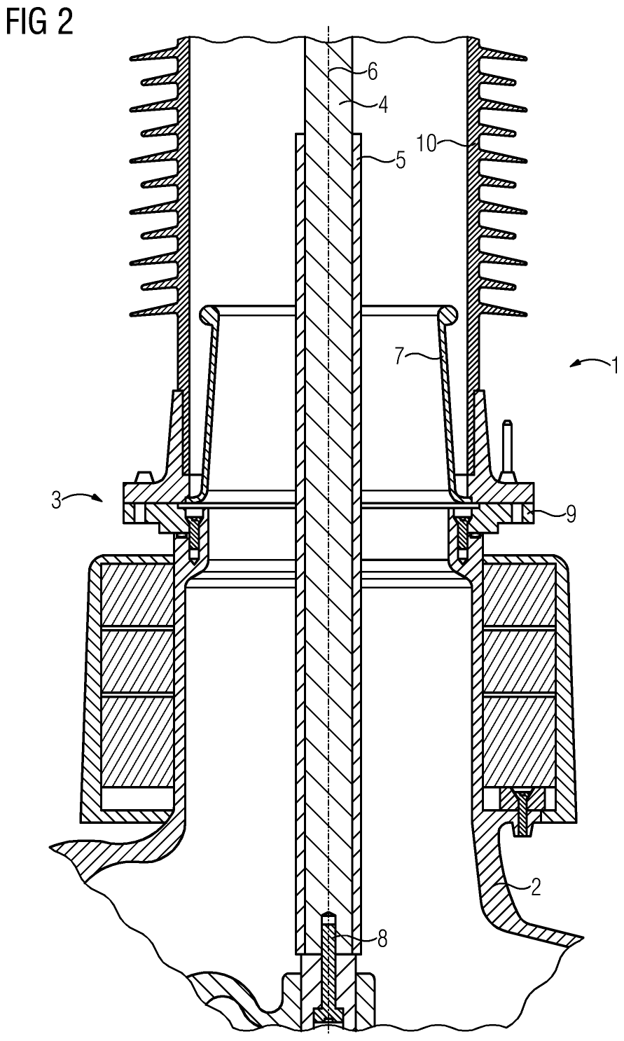

FIG. 2 schematically shows a sectional view of a detail of a high-voltage device 1 according to the invention, having an opening in an encapsulation housing 2, and having a bushing 3 for a live conductor 4 through the opening, wherein the electrical conductor 4 is coated using an insulating layer 5.

An electrical conductor 4 is shown in FIG. 1, which is used in a high-voltage device according to the invention as a live conductor for electrically connecting power consumers, power generators, and/or power lines in a power grid. The electrical conductor 4 is formed in the form of a circular-cylindrical rod or a circular-cylindrical tube, having a lateral surface which is partially coated using an insulating layer 5. The electrical conductor 4 is, for example, made of and/or comprises copper, aluminum, and/or steel. The diameter is, for example, in the range of 1 to 10 cm and the length is, for example, in the range of 1 to 10 m.

The insulating layer 5 is made of and/or comprises, for example, silicone, Teflon, PTFE, and/or PCTFE. The layer thickness is, for example, in the range of several millimeters up to centimeters, in particular 1 cm. In the exemplary embodiment of FIG. 1, the electrical conductor 4 is only partially coated using the insulating layer 5, for example only on half of its length. The coating thickness and the coating length are dependent here, for example, on the shape and size of the bushing, the maximum amperages and/or voltages of the high-voltage device, the material selection of the conductor 4 and the material selection of the insulating layer 5, and/or the shape, thickness, and length of the conductor 4. The material selection, thickness, and length of the coating of the conductor 4 using an electrically insulating material are optimized in particular in such a way that the field distribution along the conductor 4 is standardized in the area, for example, of a bushing of a high-voltage device according to the invention.

FIG. 2 schematically shows a sectional view of a detail from a high-voltage device 1 according to the invention, having an opening in an encapsulation housing 2 of the high-voltage device 1. The opening comprises a flange 9, which is in the form of a ring or rim. Boreholes for fastening means, for example screws, are formed in the flange 9. A hollow-tubular insulator 10 is arranged standing perpendicularly on the flange 9, and is fastened via the fastening means, in particular screws, in a mechanically stable manner on the flange 9. The encapsulation housing 2 having flange 9 is formed, for example, from a metal, in particular aluminum. The insulator 10 is, for example, made of ceramic, silicone, and/or composite materials. In particular rim-shaped ribs for extending leakage current paths are formed on the outer circumference of the insulator 10.

The hollow-tubular insulator 10, having circular cross section, has a longitudinal axis 6 which stands perpendicularly on the opening plane of the circular opening, and intersects or penetrates the opening in the encapsulation housing 2 in the circle center point. A switching unit of a high-voltage circuit breaker, comprised by the high-voltage device 1 according to the invention, is arranged, for example, in the encapsulation housing 2 and electrically connected via conductor 4 to power consumers, power generators, and/or power lines of a power grid outside the encapsulation housing 2. An electrical conductor 4 which is a live conductor 4 in operation of the high-voltage device 1 or in the closed state of the switching unit is, as shown in detail in FIG. 1, in particular in the form of a rod or bar, having a longitudinal axis implied by or identical with the longitudinal axis 6 of the insulator.

When current flows through the electrical conductor 4, there is an electrical and magnetic field around the conductor 4. The conductor 4 is at high voltage potential, in particular up to 1200 kV, and the encapsulation housing 2 is grounded, i.e., at ground potential. The potential difference between grounded encapsulation housing 2 and live conductor 4 can result in voltage flashovers and/or short-circuits. To prevent this, the opening in the encapsulation housing 2 has a sufficient radius, which ensures a minimum distance between conductor 4 and encapsulation housing 4, which is sufficiently large to prevent voltage flashovers. The required minimum distance is dependent on the insulating gas, using which the encapsulation housing 4 and the insulator 10 are filled, for example clean air, and on the pressure of the insulating gas, for example 1 bar. Further measures can enable reductions of the minimum distance.

One possibility for reducing the minimum distance, with sufficient dielectric strength in the area of the opening in the encapsulation housing 4, is the use of an electrode 7 at ground potential, as shown in FIG. 2. The electrode 7 is made of a metal, in particular aluminum, copper, and/or steel, is in the form of a hollow cylinder or hollow tube, having circular cross section. The hollow-tubular electrode 7, having circular cross section, has a longitudinal or center axis 6 which stands perpendicularly on the opening plane of the circular opening and intersects or penetrates the opening in the encapsulation housing 2 in the circle center point. The longitudinal or center axis of the electrode 7 at ground potential is implied by or identical with the longitudinal axis 6 of the insulator 10. The electrode 7 is fastened in a mechanically stable and electrically conductive manner using fastening means, for example screws, on the flange 9 of the encapsulation housing 2 and protrudes into the insulator 10 or into its cavity in the interior. The electrode 7 changes the electrical field between encapsulation housing 2 and live conductor 4 in such a way that voltage elevations at the opening of the encapsulation housing 2 or the flange 9 are shielded by the electrode 7 or are displaced into the interior of the insulator 10.

According to the invention, further shielding of the electrical field or changing of the field between encapsulation housing 2 and electrical or live conductor 4 is possible by using an insulating layer 5 on the electrical conductor 4. The insulating layer 5 changes the electrical field along the electrical conductor 4 in such a way that it is made uniform and is displaced further into the interior of the insulator 10 and into the encapsulation housing 2. The probability of free strong electrons for initiating an electrical discharge between electrical conductor 4 and encapsulation housing 2 is inhibited. Local field elevations due to a surface roughness on the surface of the electrical conductor 4 are reduced or prevented. Voltage flashovers and/or short-circuits between the encapsulation housing 2 and the live conductor 4 are thus prevented, even with reduced size of the opening in the encapsulation housing 2 or the flange 9, low insulating gas pressures, upon use of alternative insulating gases, such as clean air, and/or elevated voltage levels in operation of the high-voltage device 1.

Material savings and lower costs for materials with smaller sizes and wall thicknesses of encapsulation housings 2 and insulators 10 are linked thereto, lower weight with increased dielectric strength in the area of the bushing 3 of the live conductor 4 through the opening in the encapsulation housing 2, and the use of alternative switching gases is possible, such as clean air, at low pressures, for example 1 bar. The reliability and service life of the high-voltage device 1 are increased and maintenance expenditure is reduced.

The above-described exemplary embodiments can be combined with one another and/or can be combined with the prior art. Thus, for example, high-voltage devices 1 can comprise high-voltage circuit breakers, isolators, transformers, arrestors, measurement transducers, and/or bushings. High-voltage devices 1, in particular circuit breakers, are, for example, designed as gas-insulated circuit breakers, i.e., gas-insulated switch gears. The basic principle, having an insulating layer on a conductor in a bushing of the conductor through openings at ground potential, is also usable in open air circuit breakers or open air high-voltage devices. The invention is usable in dead tank facilities, i.e., with a switching unit arranged in a grounded housing. However, the basic principles are also usable in live tank facilities, i.e., with a switching unit at high voltage potential arranged in an insulator. The electrical conductor 4 is made, for example, circular cylindrical. Further shapes, for example having elliptical cross section and/or formed as a truncated cone, are also possible.

The encapsulation housing 2 of the high-voltage device 1 is, for example, in the form of a vessel, and is closed gas-tight via the insulators 10. Vessels are, for example, spherical or cylindrical, further shapes are also possible. Connections between elements of the high-voltage device are carried out, for example, in a mechanically stable manner via fastening means, in particular screws, and at least one flange. Further or alternative connection technologies, in particular adhesive bonds, welded bonds, and/or soldered bonds, are also applicable. The use of seals for the gas-tight connection of elements, in particular copper seals, is possible. Electrode ends, in particular of the electrode 7 at ground potential, are rounded, for example, to avoid field elevations. Further shapes of the electrode ends, for example extending linearly, angled, rounded having different rounding radii, are possible.

The insulating layer 5 on the electrical conductor 4 is formed, for example, as a layer or as a layer stack made up of multiple layers. The layers can have differing permittivity, in particular decreasing permittivity from layer to layer, for example with the highest permittivity of the layer directly in connection with the at least one electrical conductor 4. Due to the application of further insulating layers having different relative permittivity, wherein, for example, the permittivity of the inner layer is highest and each further layer is formed having a lower or having decreasing permittivity, but always having a permittivity greater than the permittivity of gas, i.e., greater than 1, more pronounced equalization of the electrical field can be achieved in comparison to only one layer, to thus further relieve the critical areas dielectrically.

### LIST OF REFERENCE NUMERALS

1 high-voltage device
2 encapsulation housing
3 bushing
4 live conductor
5 insulating layer
6 longitudinal or center axis
7 electrode at ground potential
8 contact means
9 flange
10 insulator

1-14. (canceled)

15. A high-voltage device, comprising:
an encapsulation housing;
at least one bushing for guiding at least one electrical conductor into said encapsulation housing and/or out of said encapsulation housing; and
an insulation layer coated on said at least one electrical conductor.

16. The high-voltage device according to claim 15, wherein said at least one electrical conductor is completely coated with said insulating layer along an entire length of said conductor.

17. The high-voltage device according to claim 15, wherein said at least one electrical conductor is coated with said insulating layer exclusively in a region of said bushing.

18. The high-voltage device according to claim 17, wherein said at least one electrical conductor is coated with said insulating layer exclusively at an opening in said encapsulation housing.

19. The high-voltage device according to claim 15, wherein the insulating layer has a relative permittivity of approximately 1 or the relative permittivity of said insulating layer is greater than 1.

20. The high-voltage device according to claim 15, wherein said insulating layer is formed of a plurality of layers.

21. The high-voltage device according to claim 20, wherein said plurality of layers have a decreasing permittivity from layer to layer.

22. The high-voltage device according to claim 21, wherein a layer that is in direct contact with said electrical conductor has a highest permittivity.

23. The high-voltage device according to claim 15, wherein said insulating layer consists of at least one polymer material selected from the group consisting of silicone, Teflon®, polytetrafluoroethylene (PTFE), and polychlorotrifluoroethylene (PCTFE); or said insulating layer comprises at least one polymer selected from the group consisting of silicone, Teflon®, PTFE, and/or PCTFE.

24. The high-voltage device according to claim 15, wherein said insulating layer has a layer thickness in a range of millimeters or in a range of centimeters.

25. The high-voltage device according to claim 15, wherein a thickness of said insulating layer and a dielectric permittivity of said insulating layer are selected such that a field strength at a surface of said electrical conductor equals a field strength at an outer surface of said insulating layer.

26. The high-voltage device according to claim 15, wherein said encapsulation housing includes a flange and an insulator fastened in a mechanically stable manner on said flange.

27. The high-voltage device according to claim 26, wherein said insulator is at least one of a hollow-tubular or circular-cylindrical insulator made of at least one material selected from the group consisting of silicone, ceramic, and composite material and having ribs formed on an outer circumference thereof, and wherein a center axis of said insulator is coaxial with a longitudinal axis of said at least one electrical conductor.

28. The high-voltage device according to claim 15, wherein at least one electrode at ground potential is enclosed by said bushing.

29. The high-voltage device according to claim 15, which comprises at least one switching unit of a high-voltage circuit breaker arranged in said encapsulation housing and/or connected via said at least one electrical conductor to power consumers, power generators, and/or lines of a power grid.

30. The high-voltage device according to claim 15, wherein said at least one electrical conductor consists of a metal or a metallic alloy and has a shape of a bar and/or a rod.

31. The high-voltage device according to claim 15, wherein said metal is selected from the group consisting of copper, aluminum, and steel, and said bar is circular-cylindrical.

32. The high-voltage device according to claim 15, wherein said encapsulation housing and/or said bushing are filled with clean air.

33. A method of increasing a dielectric strength in a high-voltage device, the method which comprises coating at least one electrical conductor with an insulating layer in a region of a bushing through which the at least one electrical conductor leads into, or out of, an encapsulation housing of the high-voltage device.

34. The method according to claim 33, which comprises forming a high-voltage device having an encapsulation housing, at least one bushing for guiding at least one electrical conductor into said encapsulation housing and/or out of said encapsulation housing, and an insulation layer coated on said at least one electrical conductor.
